(19) United States
(12) Patent Application Publication
(10) Pub. No.: US 2019/0001188 A1
(43) Pub. Date: Jan. 3, 2019

(54) SYSTEMS AND METHODS FOR COORDINATED PLAYER DEVELOPMENT WITH DATA ANALYTICS FOR VIDEO AND SENSOR INPUT

(71) Applicant: DAVIS SPORTS, INC., Sacramento, CA (US)

(72) Inventor: William M. DAVIS, Sacramento, CA (US)

(73) Assignee: DAVIS SPRORTS, INC.

(21) Appl. No.: 16/022,454

(22) Filed: Jun. 28, 2018

Related U.S. Application Data
(60) Provisional application No. 62/526,888, filed on Jun. 29, 2017.

(51) Int. Cl. A63B 24/00; A63B 71/06; G06F 3/0481; G06F 3/0485; G06F 3/0482

(52) U.S. Cl. CPC A63B 24/0062; A63B 71/0622; A63B 2069/0004; G06F 3/0485; G06F 3/0482; G06F 3/04817

(57) ABSTRACT

Example implementations are directed to a method of managing player performance data and player evaluation data for a plurality of players. According to an example embodiment, a processor operatively coupled to the memory, wherein the processor is configured to: manage a plurality of player profiles, wherein a player profile of the plurality of player profiles is associated with multimedia content, and wherein the player profile is linked with a primary account and one or more secondary accounts; receive input from the one or more secondary accounts linked with the player profile; update the player profile in view of the input; generate a player report based on the updated player profile; and provide the player report to at least the primary account linked to the player profile.

### 1. TECHNICAL FIELD

The embodiments described herein are related to data analytics and more specifically to data analytics for coordinated player development including video data and sensor data.

### 2. BACKGROUND

The youth baseball training and development industry has grown over the years with professional instruction becoming an integral resource to player development. Ex-professional and college players, coaches and scouts are providing individual and small group instruction to developing athletes of all ages to aid in fundamental skill areas, such as, hitting, defense, pitching, etc. However, the instructor does not typically also serve as the game coach. Accordingly, player development suffers from poor coordination and communication with the knowledge base or priorities between the coach, the instructor, parents, and the player.

When players receive incongruent or conflicting information, developing skills and/or techniques are not consistently reinforced through the player development life cycle, thereby resulting in detrimental development lost. For example, a skill drilled during an instructor session may not be capitalized on during an in-game opportunity. A player may be working on a specific skill with an instructor, such as a specific pitch, but the player is typically not given the opportunity to use the specific pitch in a game due to the coach's lack of familiarity with the player's latest skill developments. Conventionally, a lack of communication between instructors and coaches retards the overall development and effectiveness of the player's skill development (e.g., pitching, hitting, defense, etc.).

### SUMMARY

Systems and methods for including managing player performance data and player evaluation data for a plurality of players are described herein. According to an example embodiment, a processor operatively coupled to the memory, wherein the processor is configured to: manage a plurality of player profiles, wherein a player profile of the plurality of player profiles is associated with multimedia content, and wherein the player profile is linked with a primary account and one or more secondary accounts; receive input from the one or more secondary accounts linked with the player profile; update the player profile in view of the input; generate a player report based on the updated player profile; and provide the player report to at least the primary account linked to the player profile. These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

The structure and operation of the example implementations will be understood from a review of the following detailed description and the accompanying drawings in which like reference numerals refer to like parts and in which:

FIG. 1 illustrates an overview of a system in accordance with an example implementation.

FIG. 2 illustrates an example player development engine in accordance with an example implementation.

FIG. 3 illustrates a flow diagram of an example sequence in accordance with an example implementation.

FIG. 4A-4B illustrates an example account structures in accordance with an example implementation.

FIG. 5 illustrates an example profile configuration flow diagram in accordance with an example implementation.

FIG. 6 illustrates an example server computing environment with an example computer device suitable for use in example implementations.

FIG. 7 illustrates an example networking environment with example computer devices suitable for use in example implementations.

FIG. 8 illustrates a block diagram of an example computing device or system that may be used in connection with various example implementations described herein.

FIGS. 9-30 illustrate graphical user interfaces for client player development application in accordance with various example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

Described herein is an application tool that facilitates coordinated player development between multiple parties. An example aspect of the application tool includes tools to coordinate communication between instructors and coaches that foster a collaborative environment in the skill development of a player. The application tool provides a platform for coordination and feedback between coach and instructor to accelerate player development.

Accordingly, example implementations of the methods and systems associated with the present inventive concept include a rating system for specific skill performance evaluation, assessment tools for coach/instructor evaluations and comments, and the ability to add videos clips for observation of the player in action with a player report.

An example implementation includes generating a development model for the player that can be created and maintained by multiple users (e.g., both the coach and instructor). The development models are a foundation for preparing focused individual lesson plans for instructors. Data structures are generated to store player development chapters associated with the development model that are associated for each player profile. The application tool includes reports, player ratings, and development tracking for instructors and coaches.

By reducing the friction of capturing player performance and documentation of instructor feedback, coaches are able to leverage the up-to-date information for game plans and player utilization. Player development is accelerated with the coordinated feedback from multiple sources of support and instruction. The application tools include customized graphical user interfaces (GUIs) based on the user roles and relationships that operate on handheld devices (e.g., smartphone, tablet, etc.).

Supporters of a player's development can include a range of interested parties, such as, parents, mentors, sports therapists, specialist instructors, assistant coaches, coaches, etc. According to an example implementation, the application tools include a supporter's portal that allows supporters (e.g., parents, mentors, etc.) to input information and media for review and evaluation by the instructors and coaches. In an example, parents can upload videos of the player from a prior season or camp session and instructors can provide an initial rating based on the videos.

An example aspect facilitates creation of comprehensive player profiles with scouting and recruitment modules for sharing digests of the player development history for a next level or team. The development module includes focused individual lesson plans with recorded feedback and player development report cards that identify skill level strengths and weaknesses.

For example, the feedback from a coach or parent can be leveraged by an instructor to refine the individual lesson plans to focus on skill areas that need improvement based on a consensus rating. The coordinated feedback for player development reduces instructor bias by gathering input from multiple observers of the player's performance in different settings. The evaluation system includes a rating protocol that weights objective and subjective data points to track and analyze a player's development. For team settings, the rating protocol includes a team performance factor to measure macro-changes as well as opponent scouting factors to adjust in-game performance characteristics.

Accordingly, example implementations of the methods and systems associated with the present inventive concept are directed to analyzing information associated with video clips and biometric sensor readings as elements of a player evaluation. The analyzed information and evaluation metrics are included with communication and feedback tools for effective player development among the multiple parties supporting the player's development and/or interested in reviewing the development information. Example aspects of the disclosure create efficient communication and saves time for instructors, coaches, parents, and players that accelerates the player development in large, medium, or small settings (e.g., teaching environments, instruction sessions, academic settings, camp programs, other environments, etc.). The ratio of instructors per player is increased without losing effectiveness through the intelligent communication and analytics.

The player development platform includes integration with various video and sensor platforms to gather input, as well as, context focused training tools (e.g., sport focused, position focused, league focused, etc.) to provide measurement and evaluation performance data. For example, the present disclosure includes a rating integration module that consolidates feedback from electronic performance measuring tools and can convert the data into other industry accepted evaluation scoring protocols.

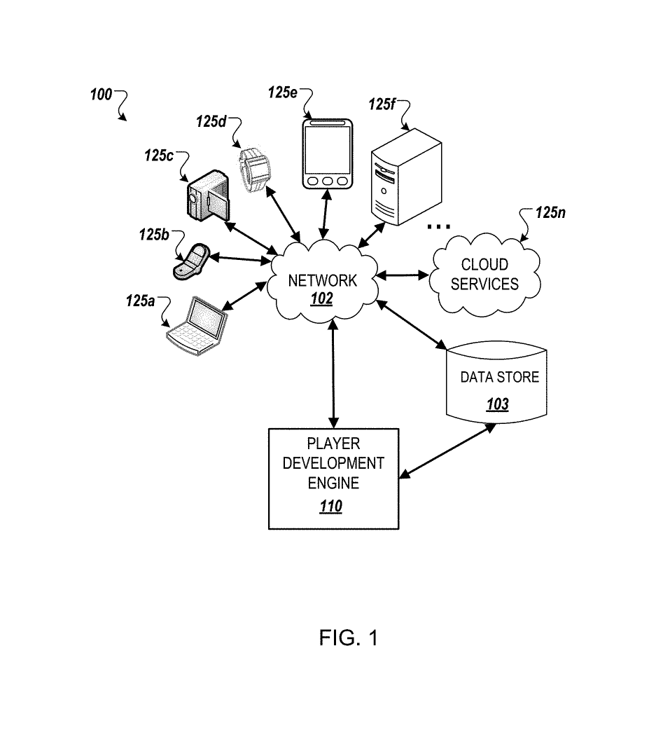

FIG. 1 illustrates an overview of a system 100 in accordance with an example implementation. The system 100 includes a player development engine 110 configured to communicate with one or more client devices 105a-105n to provide a player management tool to a user. The player development engine 110 may be implemented in the form of software (e.g., instructions on a non-transitory computer readable medium) running on one or more processing devices, such as the one or more client devices 105a-105d, as a cloud service 105n, remotely via a network 102, or other configuration known to one of ordinary skill in the art.

The terms “computer”, “computer platform”, processing device, and client device are intended to include any data processing device, such as a desktop computer, a laptop computer, a tablet computer, a mainframe computer, a server, a handheld device, a digital signal processor (DSP), an embedded processor, or any other device able to process data. The computer/computer platform is configured to include one or more microprocessors communicatively connected to one or more non-transitory computer-readable media and one or more networks.

The activity player development engine 110 directly or indirectly includes memory such as data store(s) 103 (e.g., RAM, ROM, and/or internal storage, magnetic, optical, solid state storage, and/or organic), any of which can be coupled on a communication mechanism (or bus) for communicating information. In an example implementation, the player development engine 110 can be hosted by a cloud service 105n and communicatively connected via the network 102 to client devices 105a-105n in order to send and receive data.

The term “communicatively connected” is intended to include any type of connection, wired or wireless, in which data may be communicated. The term “communicatively connected” is intended to include, but not limited to, a connection between devices and/or programs within a single computer or between devices and/or separate computers over the network 102. The term “network” is intended to include, but not limited to, packet-switched networks such as local area network (LAN), wide area network (WAN), TCP/IP, (the Internet), and can use various means of transmission, such as, but not limited to, WiFi®, Bluetooth®, Zigbee®, Internet Protocol version 6 over Low power Wireless Area Networks (6LowPAN), power line communication (PLC), Ethernet (e.g., 10 Megabyte (Mb), 100 Mb and/or 1 Gigabyte (Gb) Ethernet) or other communication protocols.

Data associated with the user, or the environment of the user, may come from different types of client devices 105a-105n. Client devices 105a-105n can include, for example, mobile computing devices 105a, 105b (e.g., smart phones, laptops, tablets, etc.), image capture devices 105c (camera, video recorders, motion imaging systems, etc.) sensor systems 105d (e.g., wearable technology including fitness trackers, physiological sensors, biometric sensors, location sensors, Global Positioning System (GPS) units, Bluetooth® beacons, etc.), computing devices 105e, 105f (e.g., tablets, desktops, mainframes, network equipment, etc.), as well as cloud services 105n (e.g., remotely available proprietary or public computing resources).

Client devices 105a-105n can include client services with functionality, for example, to collect and/or store sensed data, track locations, manage communications with external devices, and so forth. For example, a mobile smartphone computing device 105a can include client services as a mobile application to record video, playback video, capture player evaluation information, present player reports, messaging tools, etc. In example implementations, the player development engine 110 receives information from multiple client device 105a-105n.

Client devices 105a-105n may also collect information from one or more other client device 105a-105n and provide the collected information to the player development engine 110. For example, client devices 105a-105n can be communicatively connected to the other client device using WiFi®, Bluetooth®, Zigbee®, Internet Protocol version 6 over Low power Wireless Area Networks (6LowPAN), power line communication (PLC), Ethernet (e.g., 10 Megabyte (Mb), 100 Mb and/or 1 Gigabyte (Gb) Ethernet) or other communication protocols.

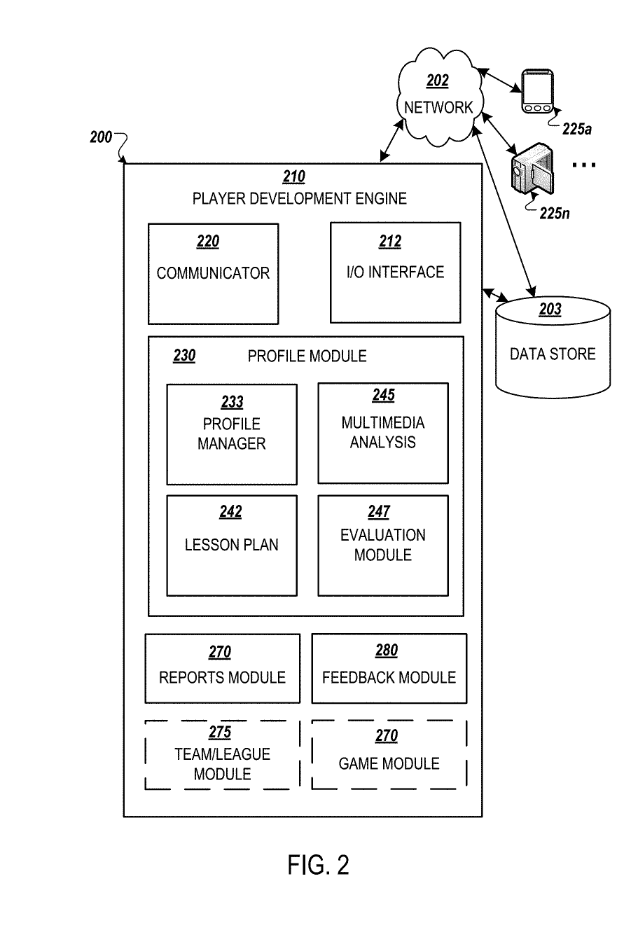

FIG. 2 illustrates an example system 200 including a player development engine 210 in accordance with an example implementation. The player development engine 210 includes one or more I/O interfaces 212, a communications module 220, a player profile model 230, a reports module 270 and a feedback module 280. The player development engine 210 is coupled to one or more data stores 203 for storing data (e.g., player profiles, metrics, videos, messages, feedback, etc.).

In an example implementation, the I/O interface 212 includes one or more communication interfaces communicatively connected with different types of client devices 205a-205n (e.g., client devices 105a-105n of FIG. 1) directly or via a network 202 in order to receive information associated with a player (e.g., videos, sensor data, messages, etc.)

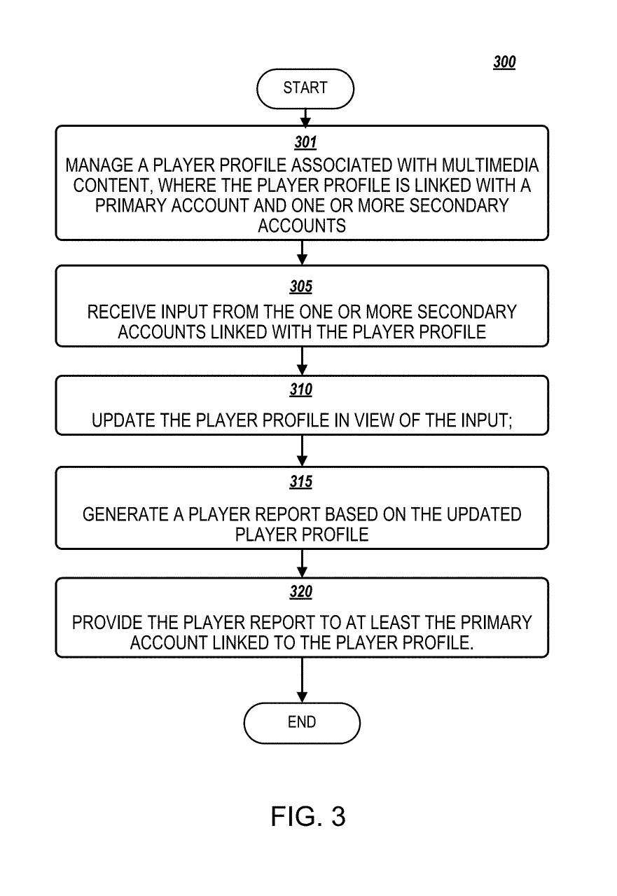

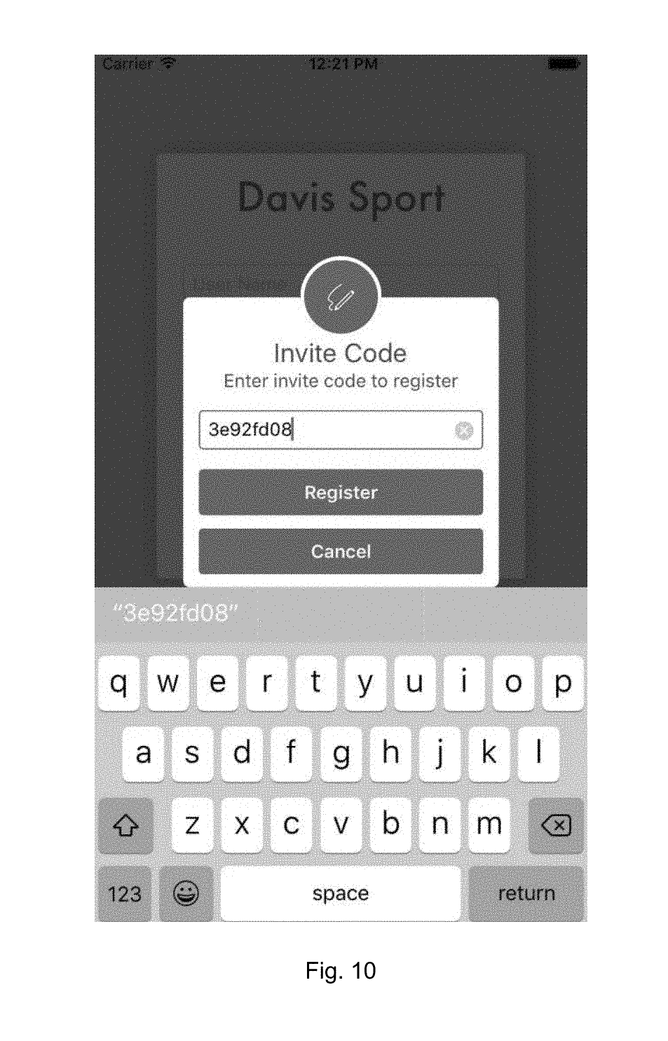

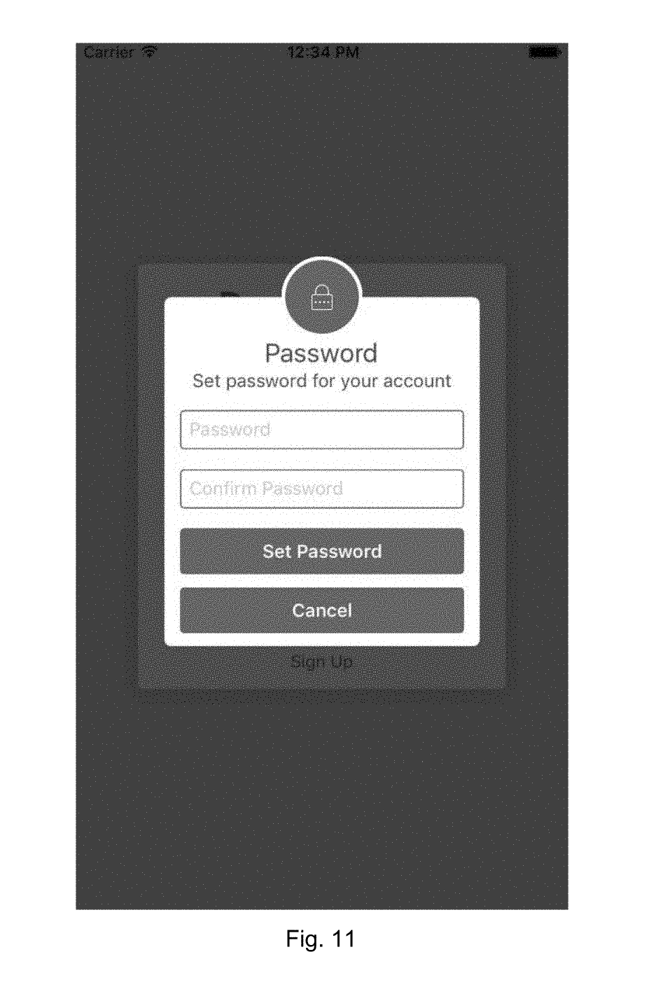

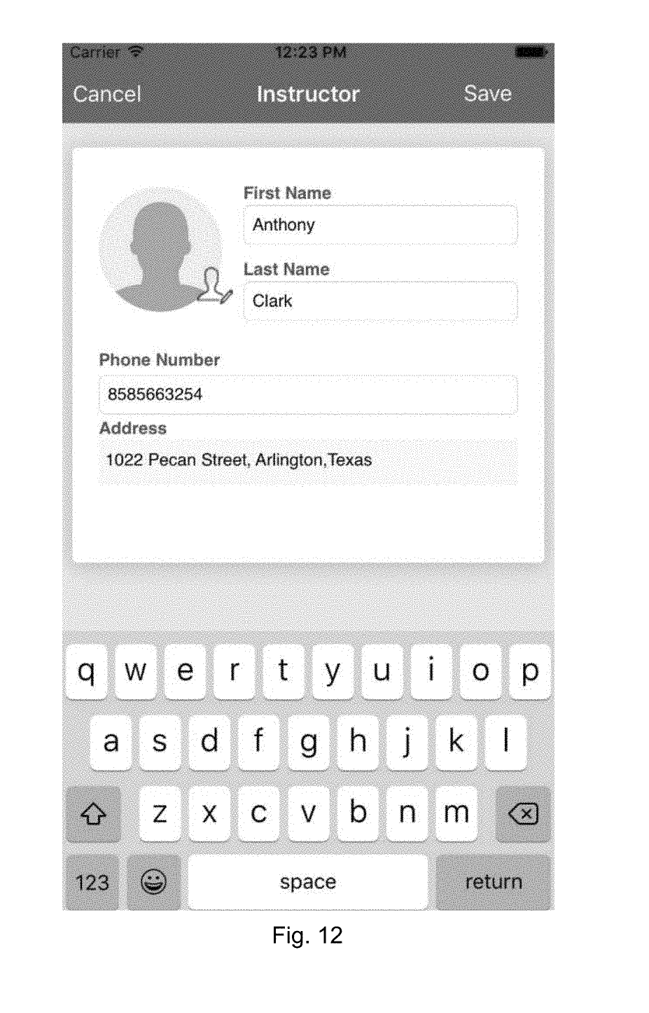

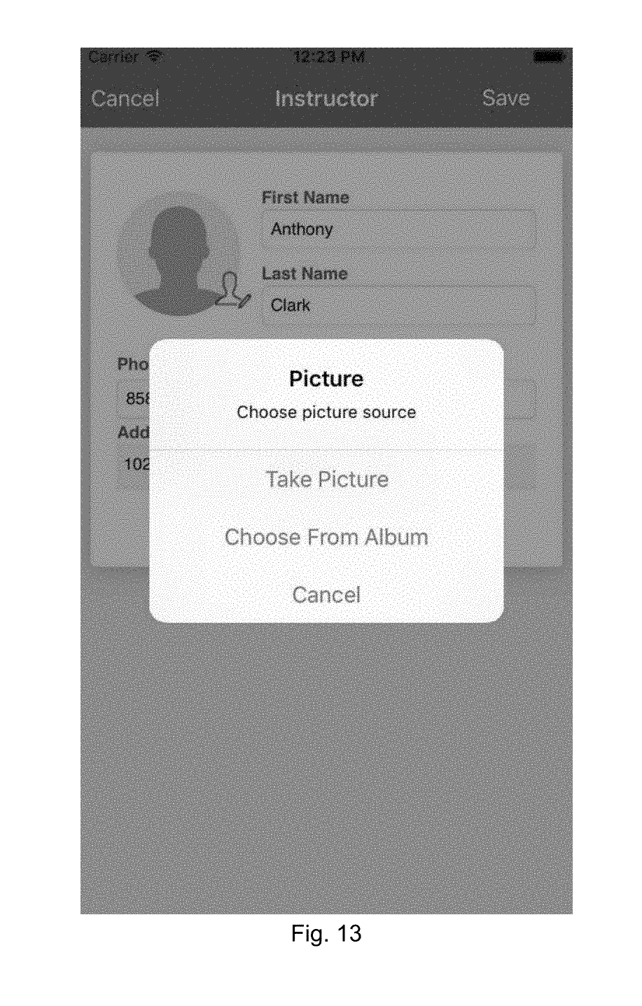

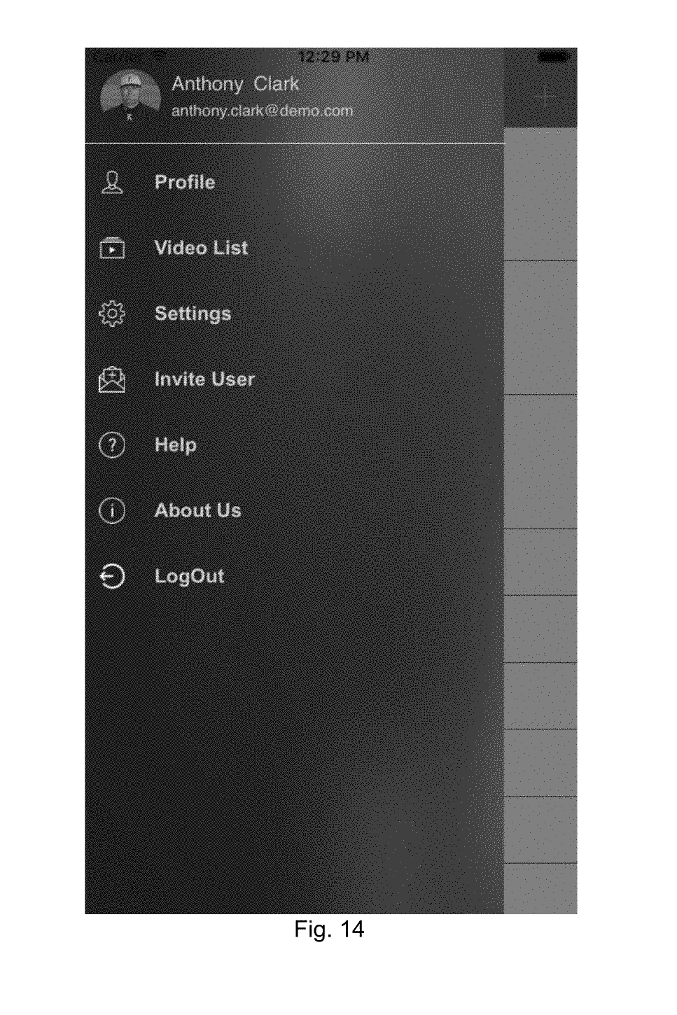

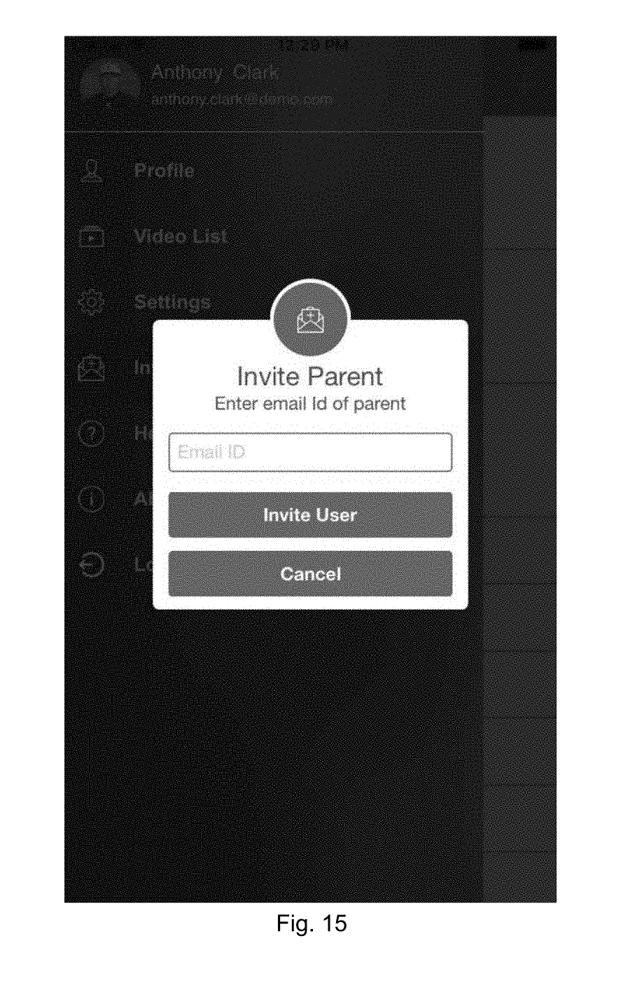

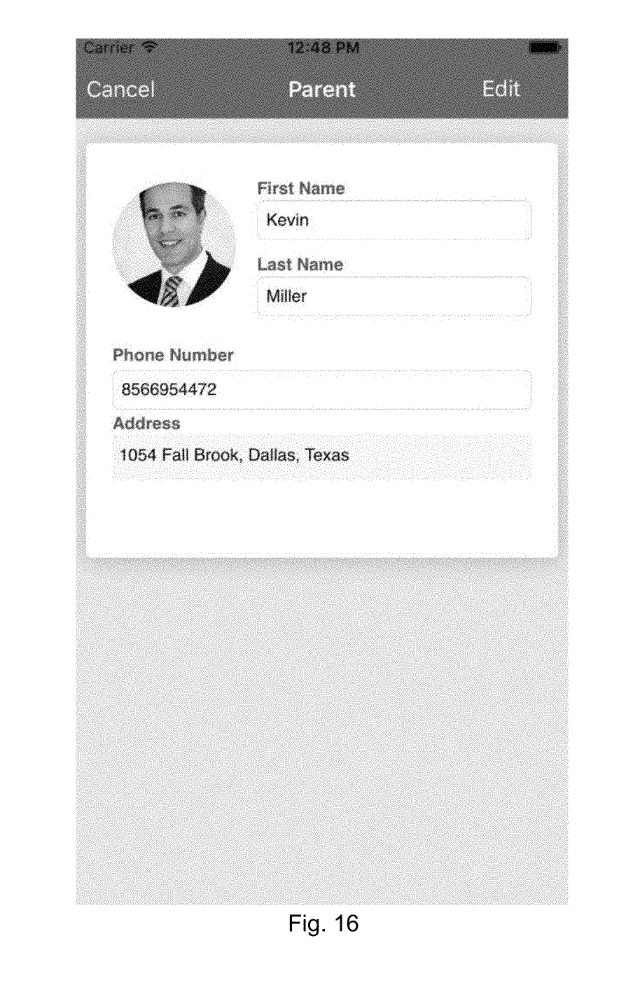

The I/O interface 212 can receive data from different types of client devices 205a-205n (e.g., client devices 105a-105n) or client services. The player development engine 210 receives, via the I/O interface 212, information such as video clips from account holders, sensor data for player performance, league statistics via an API, etc., and analyzes the information, via the player profile module 230, to gather assessments, generate player evaluations, and provide a player report for each player profile as described in greater detail below in reference to FIGS. 3-16.

For example, the I/O interface 212 can receive data from external sources, such as a hit tracker or batting sensor systems. The data from external sources received by the I/O interface 212 can be used by the player profile module 230 as performance data for skill ratings, composite scores, etc.

The player profile model 230 can include a profile manager 233, a lesson plan module 242, a multimedia analysis tool 245, and an evaluation module 247. The player profile model 230 can be used to track player performance, gather skill ratings, generate composite scores, and provide data analytics to aid coaches, instructors, and scouts in managing and developing players. In an example implementation, the player profile model 230 provides a player assessment as compared to other players and indicate opportunities for player improvement. For example, a player is rated based on their skills and compared based on a composite score to indicate what skills need to be improved to what level for the player to be improve to target percentile. For example, a pitcher can be scored as in the top 25% of pitchers at a league level, top 35% at a regional level, and top 65% at a national level. The data analytics can indicate a 15% improvement to the player's arm strength can place the player in the top 10% of pitchers at the league level, top 25% at the regional level, and top 60% at the national level.

The player profile model 230 can provide instructors with detailed analytics, reports, and lesson plans for prioritizing and targeting skill developments for a player. The player profile model 230 can be used to develop training schedules and regiments to improve a targeted skill rating. Based on player performance during the training regiment, the player profile model 230 can adjust the regiment and update projected skill achievements.

Analyzing player's skill strengths and weaknesses relative to other players within at different levels can be used to generate position recommendation based using statistical analysis. For example, the player profile model 230 can recommend one or more positions that correspond to each player's profile based on the player profiles from other teams, leagues, or historical development trends. For example, the player's current skill ratings can indicate the player is a strong third baseman and playing right field may develop the player into a strong first baseman based on historical skill developments of comparable player profiles.

Customized interfaces can include narrative input to capture a limited character field for instructor and coach to make specific comment if desired; and Video uploads to be reviewed by instructor and student during teaching sessions for added value to the learning experience. Video editing tools and automatic video processing software can be included, for example, to generate clips of 10-15 seconds long with an ability to repeat in slow motion.

According to an example implementation, additional features can include a development report card, scheduling module, and an instructor/coach rating page. The player management application is adaptable to various sports including individual and team sports. Aspects of the disclosure facilitate individual and/or small group instructions, and to non-athletic private tutoring e.g. music and dance lessons, etc. Additional modules may include, for example, a lesson payment, player recognition program, sponsor advertising space, professional scouting and college recruitment modules.

FIG. 3 illustrates a flow diagram of method 300 for a player management engine in accordance with an example implementation. The method 300 is performed by processing logic that may comprise hardware (circuitry, dedicated logic, etc.), software (such as operates on a general purpose computer system or a dedicated machine), or a combination of both. Method 300 may be performed by the player development engine 110 of FIG. 1. Though method 300 is described below as being performed by a player development engine, method 300 may also be performed by other processing logic or processing devices.

A memory (e.g., data store 103 of FIG. 1) can store player performance data and player evaluation data for multiple players. Users of the platform can have accounts to input performance data, assessments of player performances, and evaluation of the player. A player profile is generated to with the performance data and player evaluation data to create a player report as described in the process 300.

For example, a player may be supported by multiple people, such as, an instructor, coach, assistant coach, parents, etc. The player development engine (i.e. a processing device) can manage the player profiles to coordinate communication between the multiple supports and develop an evaluation for the player.

At 301, the processing device is to manage player profiles associated with multimedia content. The player profile can be linked with a primary account and one or more secondary accounts. A primary account can be associated with a coach or an instructor in charge of the player development or designated to determine and make a master evaluation for the player. For example, the player profile can include performance data, a lesson plan, and a master evaluation rating for the player. The other supporters can be designated as secondary accounts to share input and be included in the master evaluation results (e.g., player report).

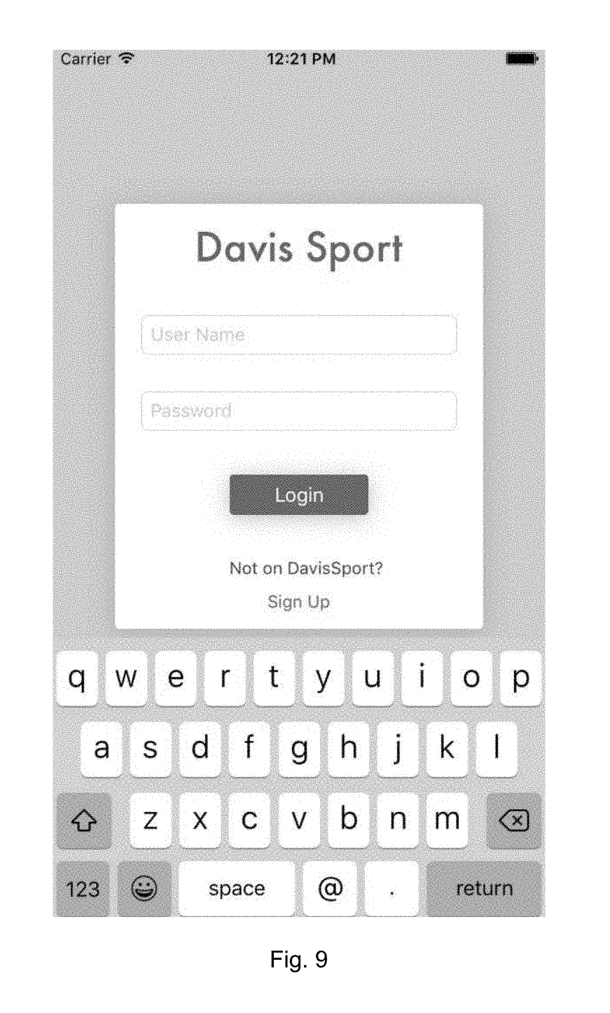

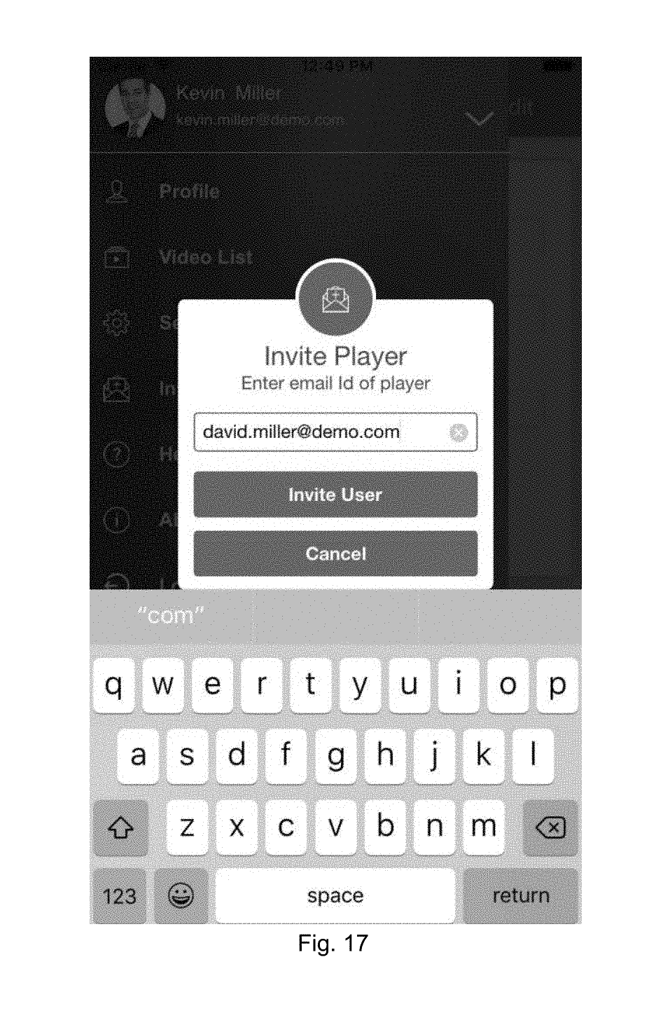

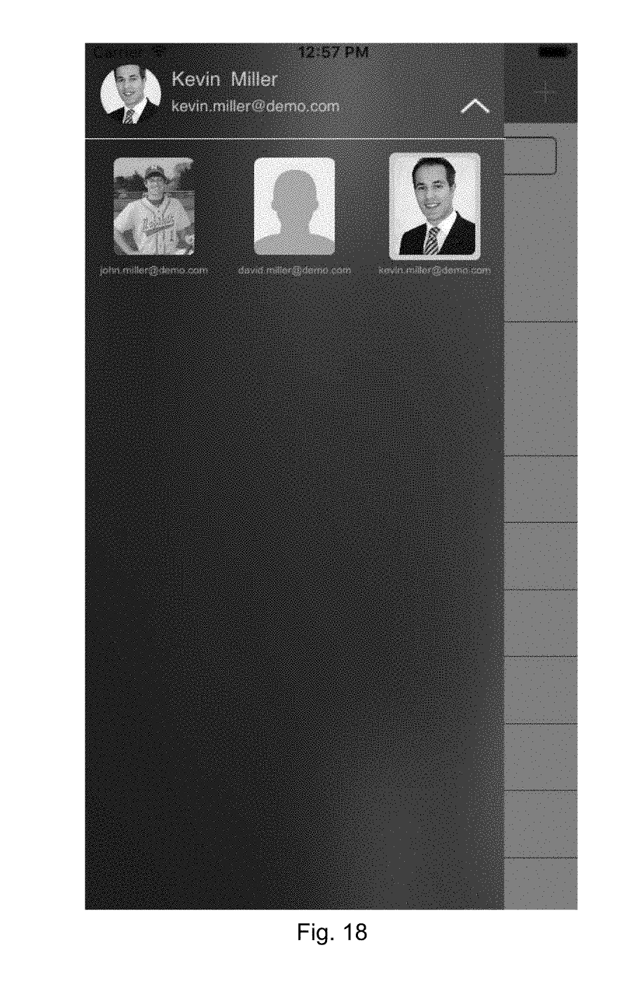

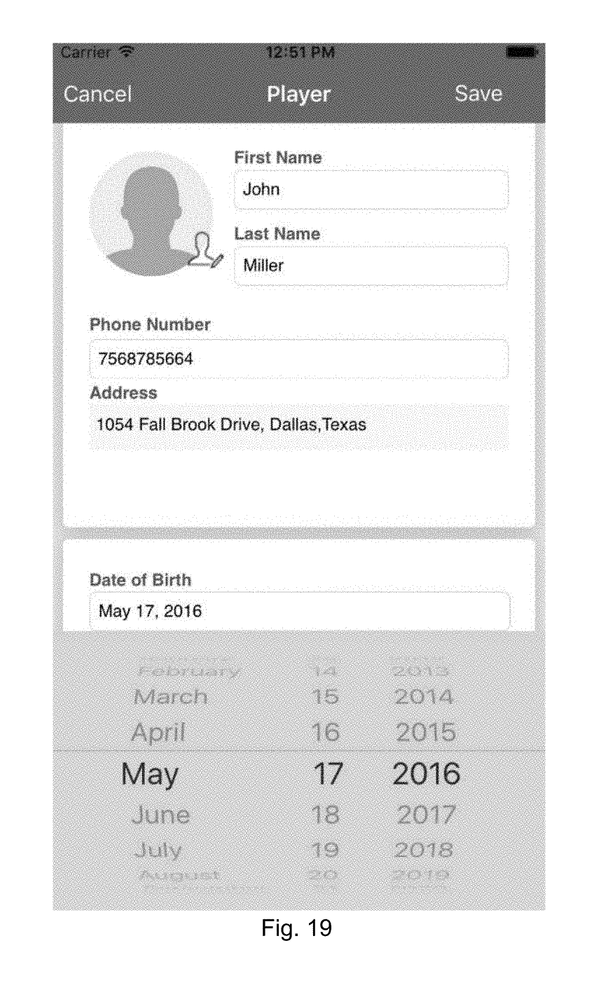

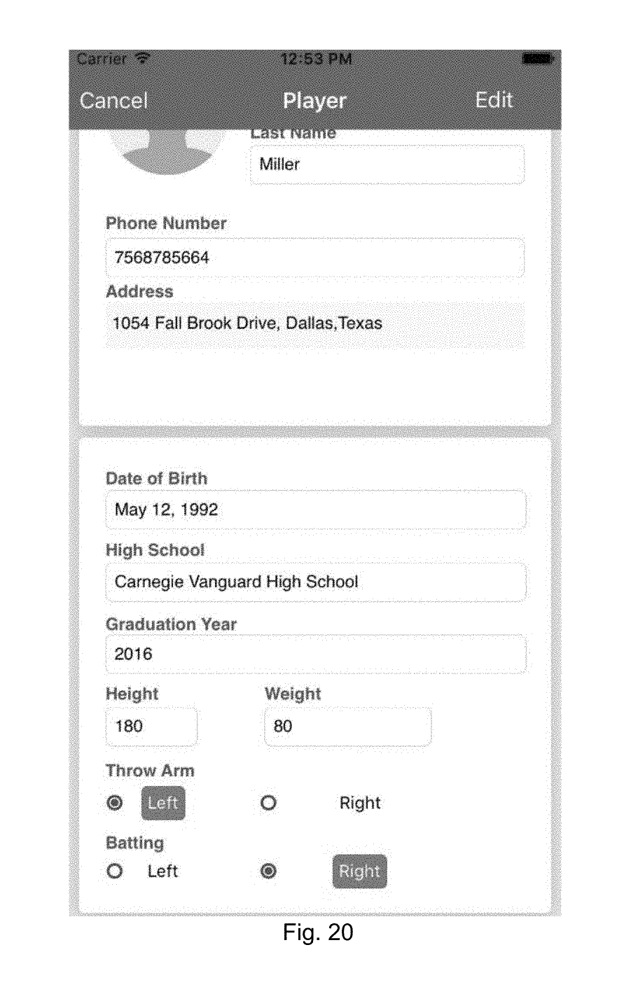

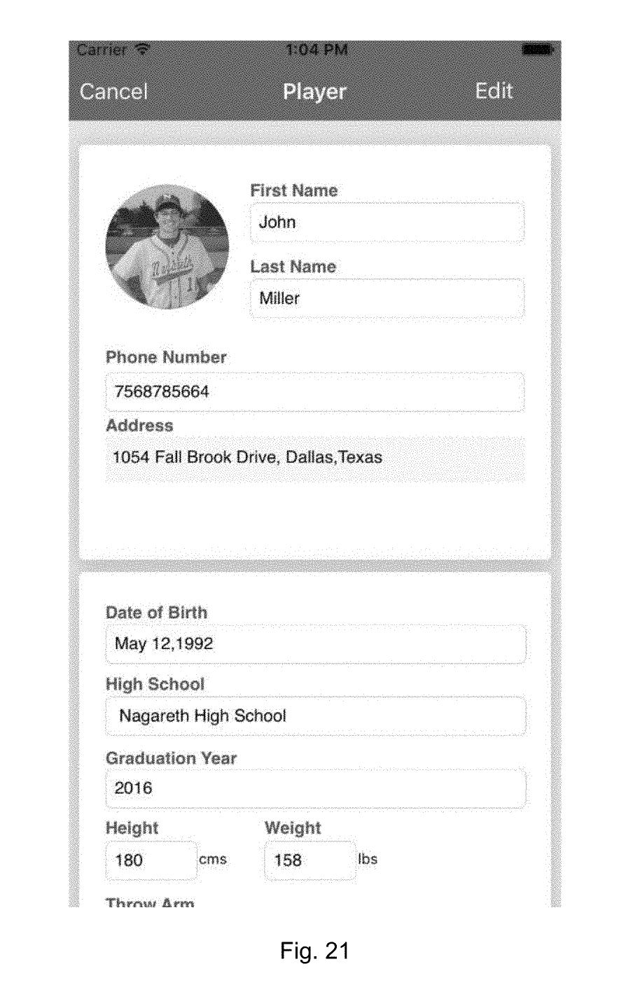

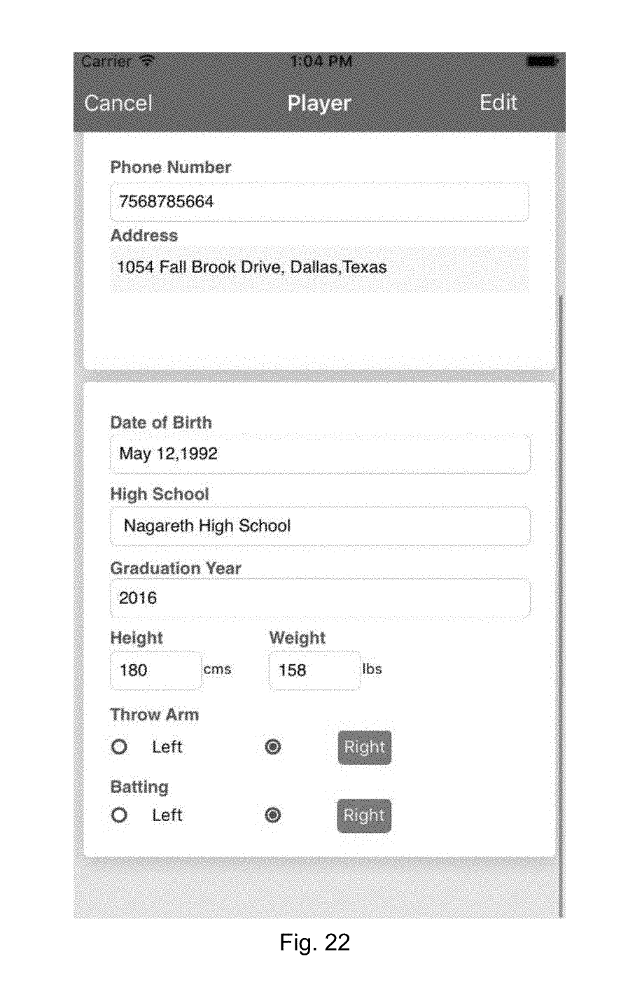

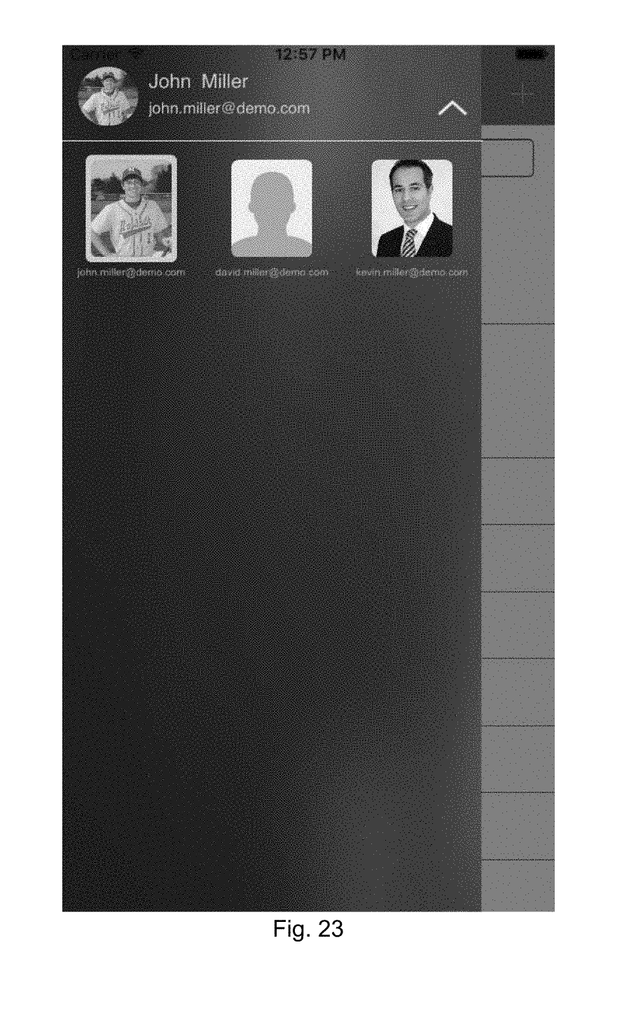

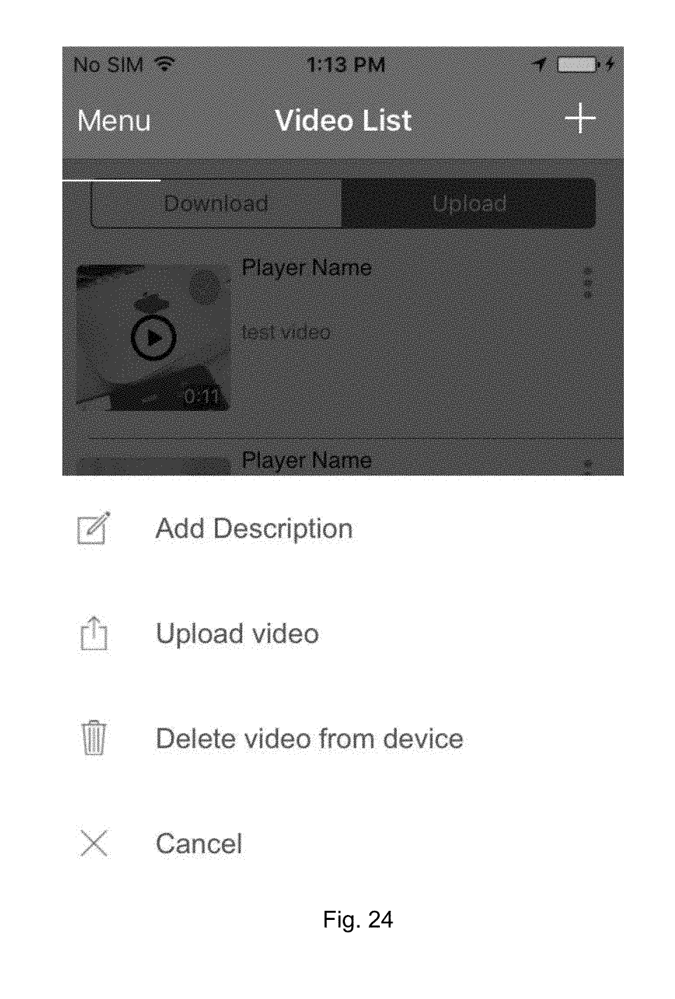

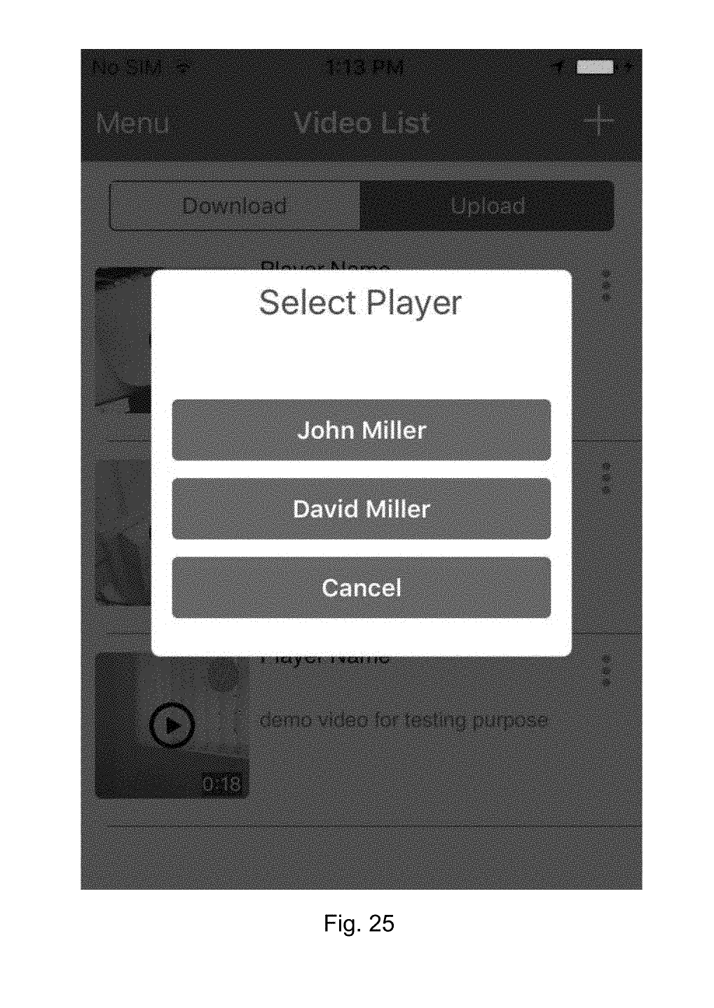

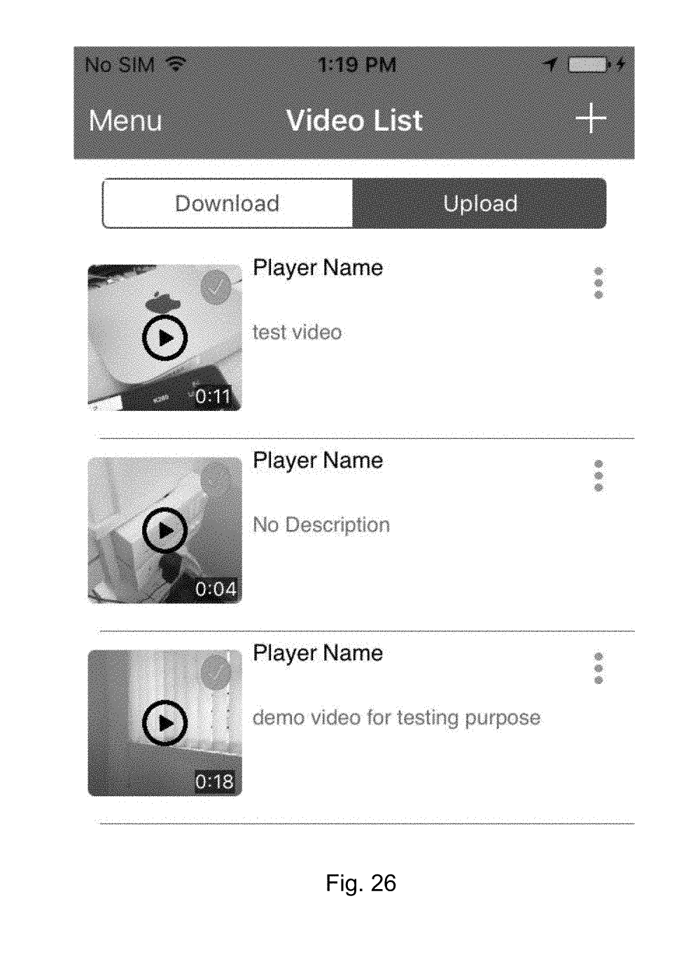

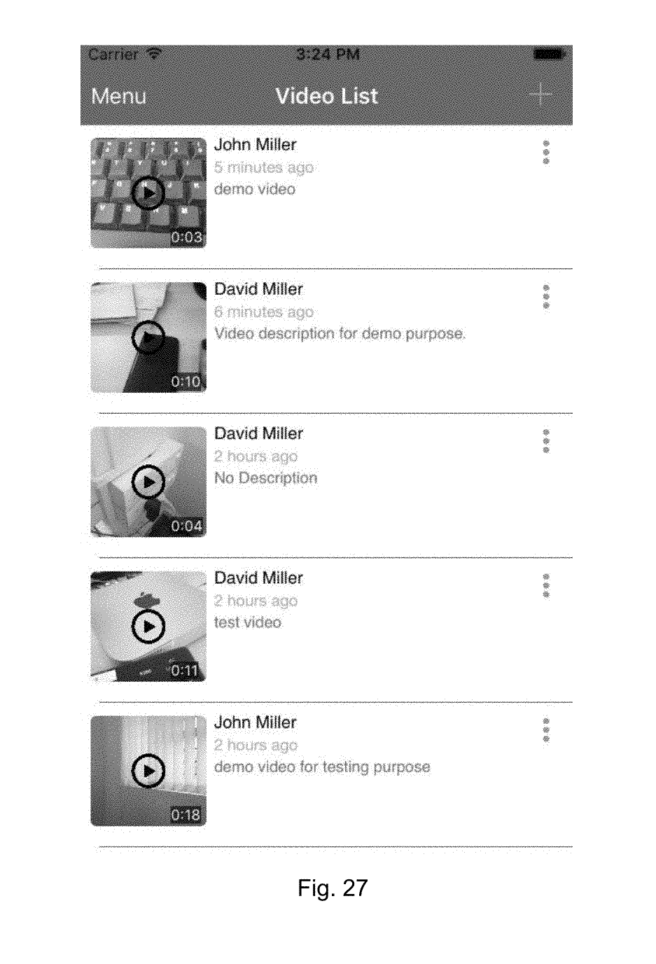

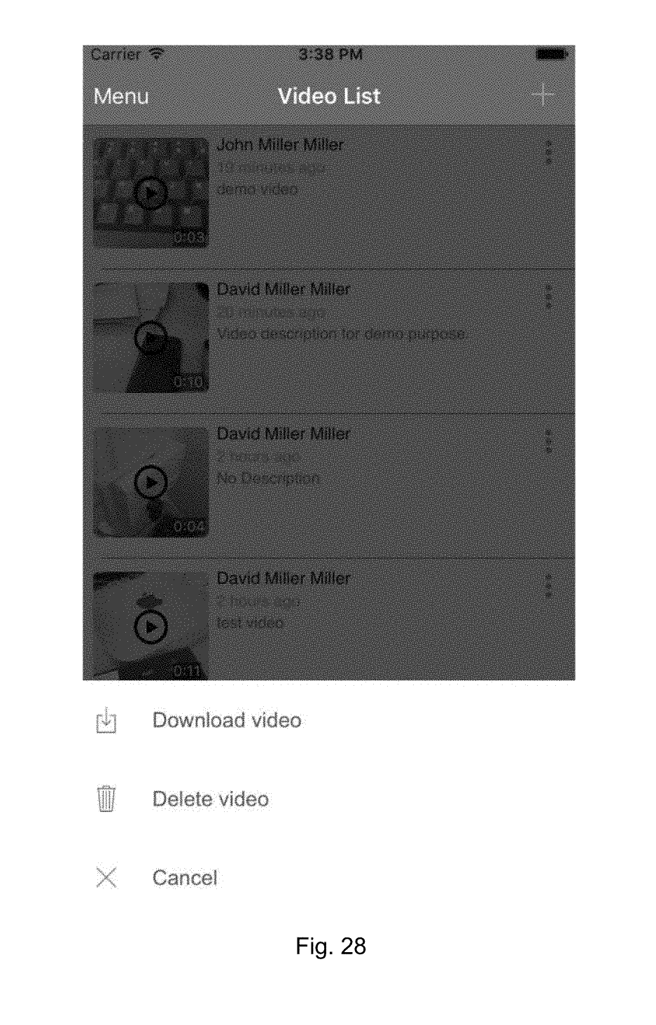

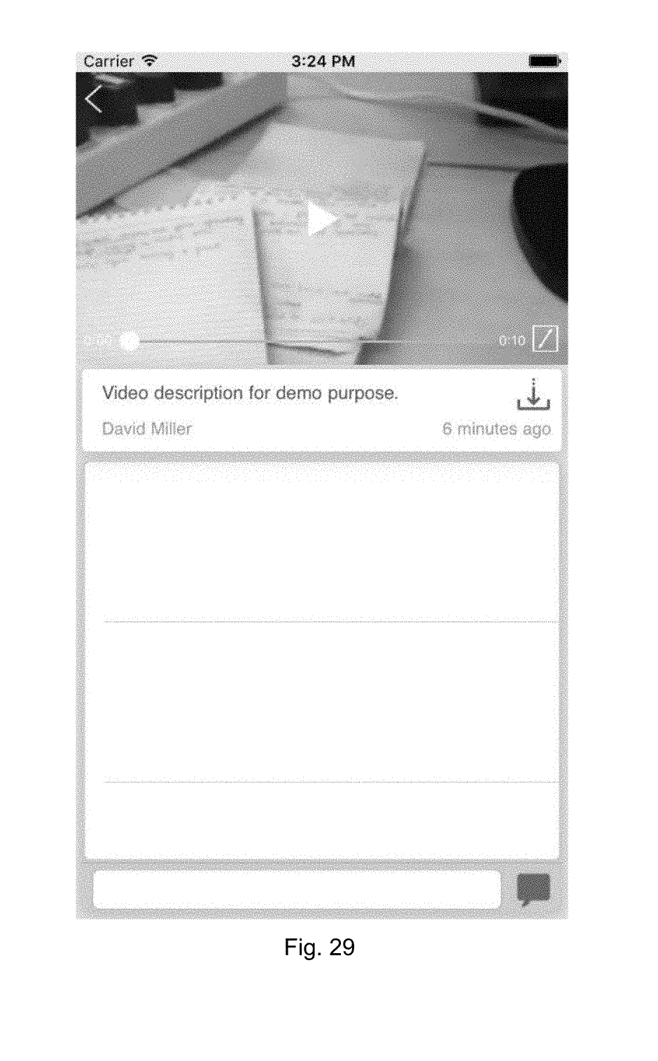

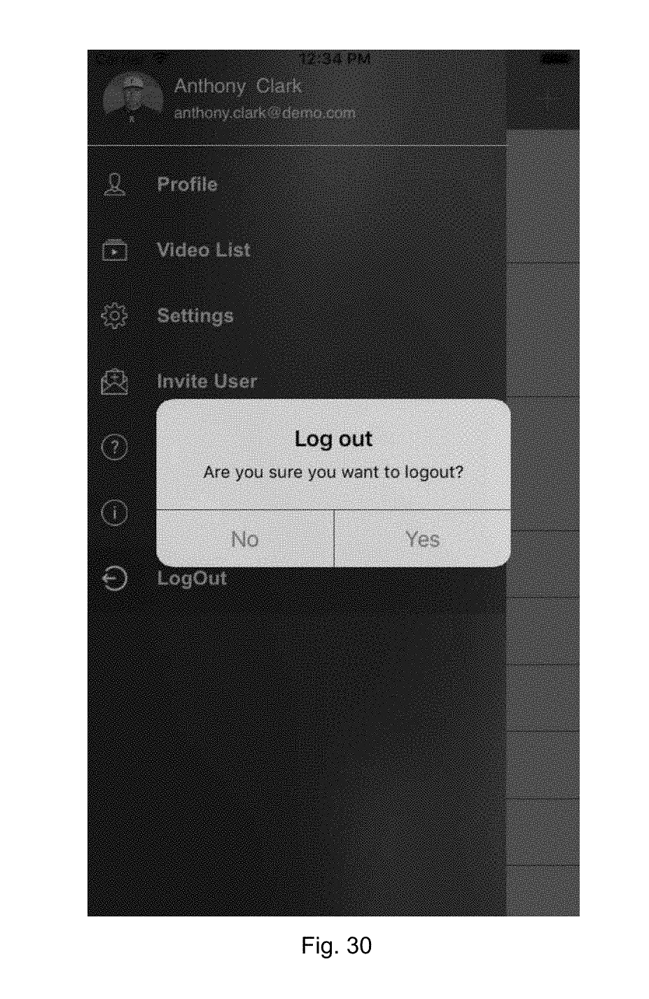

As described in reference to FIGS. 9-30, the player profile may be associated with multiple accounts through invites and include parental controls. According to an example implementation, the primary account to manage the master evaluation for the player may change. For example, an account associated with an instructor or camp specialist may be designated as a primary account during an off season and coach's account can be designated as the primary account during the season.

At 305, the processing device is to receive input from the one or more secondary accounts linked with the player profile. Input (e.g., messages, video, assessments, requests, suggestions, etc.) from the multiple secondary accounts linked to the player profile are curated by the processing device for the primary account holder. The account holder designated as the primary account for a player profile is provided interfaces to efficiently review input from the secondary accounts, assess player performance data, determine a master assessment for the player, and share the player report with one or more of the secondary accounts.

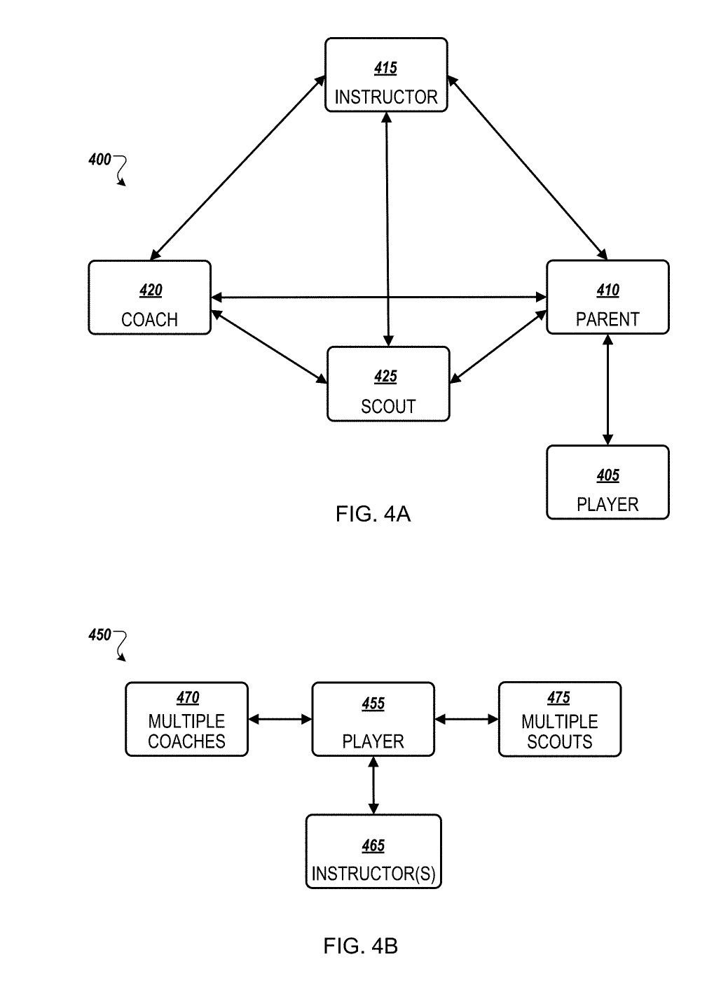

According to an example implementation, the processing device can automatically route an assessment request for the received input to one or more of the accounts. For example, a supporter may capture video of the player and the video can be routed to an account of a position coach that can provide an assessment of the video. For example, FIG. 4A-4B illustrates an example account structures in accordance with an example implementation.

The assessment request can be automatically routed based on a type of received input, based on the account the input is received from, a rules, user preferences, etc. For example, if the player is scheduled to meet with several instructors, the received input can be forwarded to the most recent instructor for assessment. Then, the assessment of the received input can be shared with the next instructor in the schedule or used to update the player report.

At 310, the processing device is to update the player profile in view of the input. According to an example implementation, the received input can include performance data such as, video, sensor readings, game statistics, etc. as well as, an assessment to evaluate performance data. To update the player profile with the received input, the processing device can re-calculate a master evaluation rating for the player according to a rating protocol by including an assessment of the received content.

For example, an overall skill rating can include arm strength, foot speed, hitting, hit for power, fielding, etc. using a formula as+fs+h+hp+f that combines (e.g., averages, normalizes, curves, etc.) the score rating for each category to calculate the player overall rating score. An updated sensor reading from a sensor for the players foot speed can be used to update the player's skill rating. According to another example, a strength coach may provide input for the player's conditioning performance (e.g., arm strength), and the processing device can update the player profile with the performance data. For example, received input can include from external sources, such as strength testing, hit tracking, batting sensor systems, etc., can be used as performance data for skill ratings, performance data, etc.

According to an example implementation, the received input can include game performance data; and the processing device can update the player profile in view of the input to recalculating the master evaluation rating for the player based on the assessment of the game performance data.

Weighting factors can be applied to generate composite scores to evaluate players within a filter category, Filter categories can include team, league, age, position, player characteristic (e.g., height, weight, left-handed, etc.) skill level, region, years of experience, etc. Regions may have different length seasons (e.g., due the number of months with playable weather), leagues may have different numbers of games, roster sizes, or level qualifications, etc., For example, a composite score to compare players within a region can be calculated without weighting regional factors, and a composite score to compare players at a national level can include the regional factors. Further, instructors can compare a player to other players at geographical, league, skill, position level, etc.

According to an example implementation, the player's performance data can be weighted relative performances of other players on a team, across a league, within a player class, geographic region, school, etc. For example, if multiple player profiles are updated with performance data that reflects a poor team performance, the processing device can discount the effect the received data has on the player profile. That is, when the received input is associated with performance data for other profiles that are teammates of the player; the player profile in view of the input can include weighting an evaluation rating of the player profile in view of the performance data of the other profiles. According to example implementations, performance data and received data can be analyzed to determine if anomalies, trends, regional changes, external factors, etc. are present to determine whether to weight or discount a set of data. For example, anomalies can be discounted to improve the quality of the data. External factors, such as an overall poor team performance, can be detected and weighted accordingly. Trends and regional difference, such as a season length, climate, competition level, are identifiable through data analytics.

At 315, the processing device is to generate a player report based on the updated player profile, and at 320, the processing device is to provide the player report to at least the primary account linked to the player profile. The player reports include the master rating for the player with drilled down skill details of the player performance data, as well as, snippets of multimedia content (e.g., video highlights).

The processing device can generate different versions of the player report based on settings. For example, the full player report is shared with a future school or the player report can be provided with assessment information and evaluation information hidden. Details on player reports can be controlled to limit the competitive intelligence provided to other teams, maximize recruiting interest, reinforce player encouragement. For example, the player's arm strength rating can be reported in detail to an instructor, reported to player at a general level, and inaccessible by coaches from other teams. Customized reports for the player can limit the distractions and help motivate a player's focus.

As mentioned, example aspects include customized interfaces for supports of the player. According to an example implementation an instructor interface can be provided to assess videos of player performance, maintain a lesson plan for the player profile, and message the one or more secondary profiles linked to the player profile. Further, a coach or instructor can manage lesson plans for player profiles so that the development lesson plan for the player profile is adapted based on the evaluation rating and performance data associated with the player profile.

A coach interface can include, for example, functionality to review a plurality of player profiles assigned to a group (e.g., position, A team, B team, etc.). The coach interface can include a customized interface for rapid video playback and assessments for each of the player profiles of the group and include filter and sorting functionality based on the player performance data.

A parent interface can include messaging, video upload portals, scheduling tools, payment tools, access the player profile, and track view of the player profile by the primary account and secondary accounts linked to the player profile.

An example rating System for individual skills can categories skills (e.g., pitching, hitting and defense players) and include a rated (i.e., assessment) on a numerical, letter, customizable scale (e.g., 1-8) in proficiency and overall progress, almost a survey format that allows quick easy input.

For example, a Hitter Exit Velocity Evaluation Ratings

Scale values: 1=Beginner

2-4=Recreational/mid travel

5-6=mid/high travel

7-8=high travel/national competition

Player Age Category 8U

7-8 rating: 70+mph

5-6 rating: 60 mph-69 mph

2-4 rating: 50 mph-59 mph

1 rating: 49-under mph

Player Category 10U

7-8 rating: 80+mph

5-6 rating: 70 mph-79 mph

2-4 rating: 60 mph-69 mph

1 rating: 59-under mph

Player Category 12U

7-8 rating: 90+mph

5-6 rating: 80 mph-89 mph

2-4 rating: 70 mph-79 mph

1 rating: 69-under mph

Player Category 13U

7-8 rating: 90+mph

5-6 rating: 80 mph-89 mph

2-4 rating: 70 mph-79 mph

1 rating: 79-under mph

High School

7-8 rating: 98+mph

5-6 rating: 90 mph-97 mph

2-4 rating: 80 mph-89 mph

1 rating: 79-under mph

An Overall Skill rating can address specific performance metrics such as arm strength, foot speed, hitting, hit for power, fielding. (5 tools) Relate app skills to an overall (5 tools) category; Formula: as+fs+h+hp+f divided by 5 (e.g., averaged)=player overall rating score.

FIG. 4A-4B illustrates an example account structures in accordance with an example implementation. The player management application facilitates communication between the instructor, parent, scout and coach creating a collaborative environment in the skill development of the player. An example implementation of the System can include predefined roles, for example, Admin, Player, Parent, Instructor, Coach, Scout.

According to an example implementation, an Admin: can be business owners of the application and have the authority to vet qualifications and then accept or reject the account request sent by the instructor and scout. Admin are responsible for the configuring the plans (subscriptions).

In an example system, the price and number of videos that can be uploaded and shared as a part of the base plan. A base “free plan” can get applied to the new user as soon as they download the app for the first time. Monthly and yearly plans for the users to purchase once they exhausted the limit of the previous plan (or the first base plan). For example, deletion of an existing plan, a grace period of 30 days would be given to the parents to download their videos (back up) stored on the server, after which the change would be in effect. During a grace period, the user would not be able to comment or share any videos.

Users can invite other user (Instructors, Coaches, Scouts, etc.) to the system (app) to view the date-wise transaction history report.

For example, an Instructor: can send invites to the parents to sign up and connect with them. The instructor can search players and scouts in the system and send a connection request. The invitation sent to the player will be sent to the parent for approval. The instructor can refer (share) player profiles associated with scouts. The instructor (e.g., primary account) can receive notification when a video has been uploaded/sent by the parent. The instructor can view, rate, and comment on each video shared by the player/parent and further download the video to their device.

Parents can have the authority to send the sign up link to their children (Player/s) to create an account to login into the application. Parents also have the ability to create and manage the player account. For example a parent may upgrade plans or buy new plans to share videos with the instructor/coach/scout or upgrade the existing plan. When the parent upgrades his/her plan mid cycle, the new plan can take affect at the beginning of the next plan billing cycle. The parent can be prompted to enter the app password again to pay for the plan upgrade.

Player: can onboard the application only on the invite received from the parents and have limited or restricted access to the application. For example, a player may be restricted from directly sharing any videos with the instructors/coaches for privacy and protection.

Coach can self-sign up to the application. They can view the profile and ratings of the players shared by the instructor with them and view the profile and ratings of the players shared by the instructor with them.

Scout: may be able download the app and admin would accept or reject the request and view the profile and ratings of the players shared by the instructor with them.

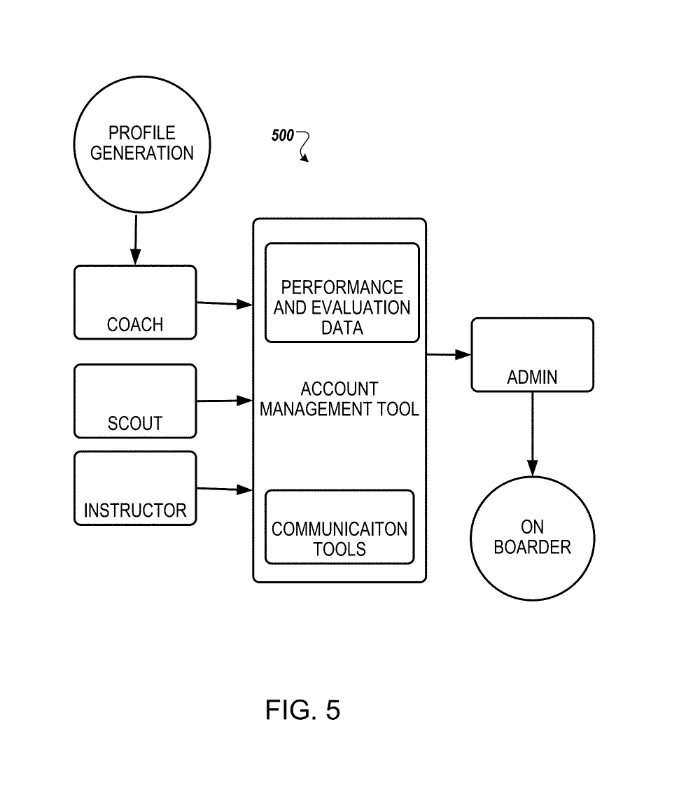

FIG. 5 illustrates an example profile configuration flow diagram in accordance with an example implementation. According to an example implementation, evaluators are onboard through a certification questionnaire and calibration process.

An example certification questionnaire for instructors can include assessments to determine 1) What is the highest level of playing experience? (Buttons) HS, JC/College, Professional. 2) Years of experience teaching, instructing, coaching? (buttons) less than 5 yrs, 5 to 10 yrs, more than 10 yrs. 3) Teaching specialty? Check all that apply (buttons) pitching, hitting, fielding, catching.

An example certification questionnaire for Coaches can include 1) What is the highest level of playing experience? (Buttons same as instructor) 2) Years of experience coaching? (Buttons same as instructor) 3) Highest level achieved? (Buttons) recreational, club, HS, JC/College, Pro.

An example Scouts certification can include What is your Professional affiliation? (Buttons list each Major League Baseball (MLB) teams, MLB Scouting Bureau, international pro organization.

An evaluator with years of experience or experience from a professional league can indicate a greater deference is to be applied to their ratings than evaluators with limited experience. For example, an evaluator that is a former professional player may indicate their input rating is more credible than an amateur scout's rating. Experience level can be used to qualify an evaluator's rating inputs. The onboarding process can access external resources to verify an experience level. For example, an evaluator that inputs former professional experience as a player, or a number of years of experience coaching can be checked against historical records to verify the experience and reduce user's from overstating qualifications.

The onboarding process can include the certification questionnaire to gather an experience history for evaluators (e.g., parent, instructor, coach, scout, etc.), and a calibration process for the evaluator's rating inputs, to determine an influence power for each evaluator.

For example, the calibration can include a rating calibration test with listings of individual skills in categories of position ratings (e.g., pitching, hitting, fielding, base running, ground balls, fly balls, strategy, etc.) to rate players on a 1-8 scale in proficiency and overall progress. The questionnaire is provided in a survey format that allows quick easy input to establish a set of baseline factors to compare players.

In example implementations, instructors can evaluate and rate skills from video clips submitted by parents with the ability to rate skill performance after one on one teaching sessions and have the evaluations roll up into an overall skill rating for each player/student. Ratings provided by evaluators can be calibrated. In an example implementation, evaluators can be presented with a standard set of calibration videos with sample players to evaluate. The standard set of videos can show players as determined by the admin to be at different skill levels and request the evaluator provide a rating for each player based on the video. The received ratings from an evaluator can be compared to a master rating and/or global rating for each calibration video. Based on the comparison, the account management tool can perform statistical analysis to determine a rating curve for the evaluator and/or influence level. For example, a rating on a 1 to 8 scale from a former professional coach may average 1 or 2 points lower than ratings from parents. The calibration can adjust the evaluator's scale to normalize among ratings from different evaluators. The calibration video can also be used to establish or adjust an evaluator's experience level and/or influence level. For example, an evaluator that provides ratings for the calibration videos that are inconsistent or incompatible with the master rating and/or globally sourced rating can indicate the evaluator has limited experience in providing ratings.

An evaluator can have different levels of influence based on the calibration. For example, a former professional player or coach with a high influence level can provide player skill ratings to the player development engine for a number of players, and the ratings can be used for generating each player's composite score and global ratings for players with corresponding characteristics (e.g., matching skill, position, age level, etc.). In an example, a parent or amateur scout with a low influence rating can provide player skill ratings to the player development engine for a number of players, and the ratings can be used for generating each player's composite score but exclude from global composite scores. That is, a low influence rating can be applied to evaluators to indicate the provided ratings are relevant to the specific player being evaluated, and due to limited experience the rating is not included when evaluating players outside of a neighborhood of data or the universe of data. In an example, evaluators can have a different influence rating based on the position or skill level. For example, a pitcher's ratings from a pitching coach can have a greater influence power than a batting skill rating from the pitching coach. In an example, a coach with limited experience coaching several years in a single league can have greater influence power for composite scores of players in that league and less influence power when reports are generated for players compared with national statistics.

The calibration process can be included as part of the on-boarded session, periodically provided (e.g., multiple times during a season) to evaluators, and/or used to train or improve ratings from evaluators. For example, an evaluator with limited experience rating players (e.g., a parent or amateur scout) can rate calibration videos and be provided with feedback regarding their rating compared to a professional with a high experience and influence rating. In an example, an evaluation video for each calibration video can provide a recorded assessment from a professional instructor to aid the low level evaluator on factors identified in the calibration video. In another example, evaluation feedback can be provided based on surveys or free text comments provided by high level evaluators. Accordingly, new coaches can improve their experience level and/or influence rating via the calibration process.

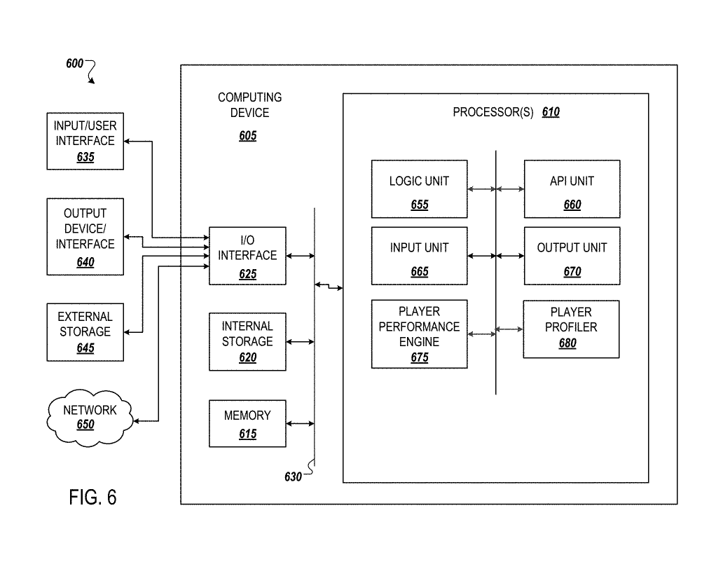

FIG. 6 shows an example computing environment with an example computing device associated with the external host for use in some example implementations. Computing device 605 in computing environment 600 can include one or more processing units, cores, or processors 610, memory 615 (e.g., RAM, ROM, and/or the like), internal storage 620 (e.g., magnetic, optical, solid state storage, and/or organic), and/or I/O interface 625, any of which can be coupled on a communication mechanism or bus 630 for communicating information or embedded in the computing device 605.

Computing device 605 can be communicatively coupled to input/user interface 635 and output device/interface 640. Either one or both of input/user interface 635 and output device/interface 640 can be a wired or wireless interface and can be detachable. Input/user interface 635 may include any device, component, sensor, or interface, physical or virtual, that can be used to provide input (e.g., buttons, touchscreen interface, keyboard, a pointing/cursor control, microphone, camera, braille, motion sensor, optical reader, and/or the like).

Output device/interface 640 may include a display, television, monitor, printer, speaker, braille, or the like. In some example implementations, input/user interface 635 and output device/interface 640 can be embedded with or physically coupled to the computing device 605. In other example implementations, other computing devices may function as or provide the functions of input/user interface 635 and output device/interface 640 for a computing device 605.

Examples of computing device 605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 605 can be communicatively coupled (e.g., via I/O interface 625) to external storage 645 and network 650 for communicating with any number of networked components, devices, and systems, including one or more computing devices of the same or different configuration. Computing device 605 or any connected computing device can be functioning as, providing services of, or referred to as a server, client, thin server, general machine, special-purpose machine, or another label.

The I/O interface 625 may include wireless communication components (not shown) that facilitate wireless communication over a voice and/or over a data network. The wireless communication components may include an antenna system with one or more antennae, a radio system, a baseband system, or any combination thereof. Radio frequency (RF) signals may be transmitted and received over the air by the antenna system under the management of the radio system.

I/O interface 625 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 600. Network 650 can be any network or combination of networks (e.g., the Internet, local area network, wide area network, a telephonic network, a cellular network, satellite network, and the like).

Computing device 605 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 605 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 610 can execute under any operating system (OS) (not shown), in a native or virtual environment. One or more applications can be deployed that include logic unit 655, application programming interface (API) unit 660, input unit 665, output unit 670, player development engine 675, and player profiler 680.

For example, input unit 665, player development engine 675, and player profiler 680 may implement one or more modules shown in FIG. 2. The described units and elements can be varied in design, function, configuration, or implementation and are not limited to the descriptions provided.

In some example implementations, when information or an execution instruction is received by API unit 660, it may be communicated to one or more other units (e.g., logic unit 655, output unit 670, input unit 665, player development engine 675, and player profiler 680.

Input unit 665 may, via API unit 660, interact with the player development engine 675, and player profiler 680 to provide the player performance data. In some instances, logic unit 655 may be configured to control the information flow among the units and direct the services provided by API unit 660, input unit 665, output unit 670, input unit 665, player development engine 675, and player profiler 680 in some example implementations described above. For example, the flow of one or more processes or implementations may be controlled by logic unit 655 alone or in conjunction with API unit 660.

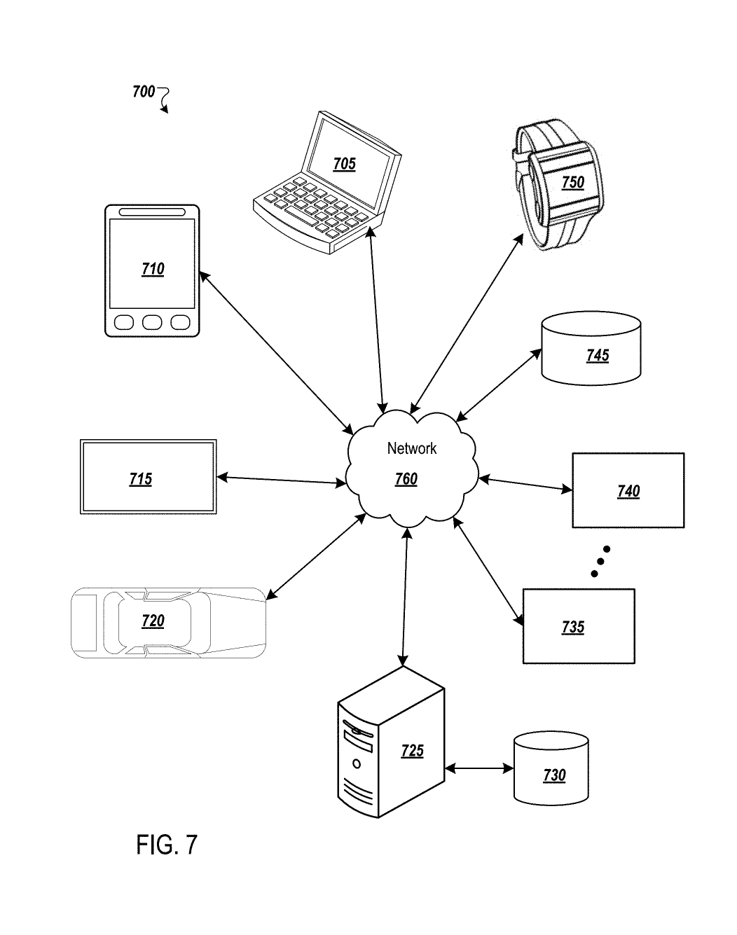

FIG. 7 shows an example environment suitable for some example implementations. Environment 700 includes devices 705-750, and each is communicatively connected to at least one other device via, for example, network 760 (e.g., by wired and/or wireless connections). Some devices may be communicatively connected to one or more storage devices 730 and 745.

An example of one or more devices 705-750 may be computing devices 605 described in FIG. 6, respectively. Devices 705-750 may include, but are not limited to, a computer 705 (e.g., a laptop computing device) having a display and as associated webcam as explained above, a mobile device 710 (e.g., smartphone or tablet), a television 715, a device associated with a vehicle 720, a server computer 725, computing devices 735-740, storage devices 730 and 745. As explained above, the meeting environment of the user may vary, and is not limited to an office environment.

In some implementations, devices 705-720 may be considered user devices associated with the users of the enterprise. Devices 725-750 may be devices associated with client service (e.g., used by the users or administrators to provide services as described above and with respect to FIGS. 4-5, and/or store data, such as performance data, evaluation data, massaging data, webpages, text, text portions, images, image portions, audios, audio segments, videos, video segments, and/or information thereabout).

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined operations leading to a desired end state or result. In example implementations, the operations carried out require physical manipulations of tangible quantities for achieving a tangible result.

Unless specifically stated otherwise, as apparent from the discussion, it is appreciated that throughout the description, discussions utilizing terms such as “receive,” “determine,” “update,” “generate,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium.

A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method operations. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application.

Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

The example implementations may have various differences and advantages over related art. For example, but not by way of limitation, as opposed to instrumenting web pages with JavaScript as explained above with respect to the related art, text and mouse (e.g., pointing) actions may be detected and analyzed in video documents.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

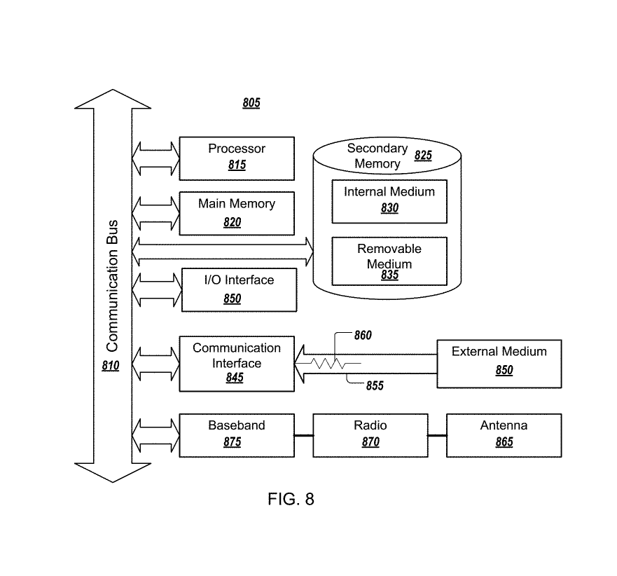

FIG. 8 provides a block diagram illustrating an example computing device or system that may be used in connection with various example implementations described herein. For example the system 805 may be used as or in conjunction with one or more of the mechanisms or processes described above, and may represent components of processors, user system(s), and/or other devices described herein. The system 805 can be a server or any conventional personal computer, or any other processor-enabled device that is capable of wired or wireless data communication. Other computer systems and/or architectures may be also used, as will be clear to those skilled in the art.

The system 805 preferably includes one or more processors, such as processor 815. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 815. Examples of processors which may be used with system 805 include, without limitation, the Pentium® processor, Core i7® processor, and Xeon® processor, all of which are available from Intel Corporation of Santa Clara, Calif.

The processor 815 is preferably connected to a communication bus 810. The communication bus 810 may include a data channel for facilitating information transfer between storage and other peripheral components of the system 810. The communication bus 810 further may provide a set of signals used for communication with the processor 815, including a data bus, address bus, and control bus (not shown). The communication bus 810 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 888 general-purpose interface bus (GPIB), IEEE 696/S-30, and the like.

System 805 preferably includes a main memory 820 and may also include a secondary memory 825. The main memory 820 provides storage of instructions and data for programs executing on the processor 815, such as one or more of the functions and/or modules discussed above. It should be understood that programs stored in the memory and executed by processor 815 may be written and/or compiled according to any suitable language, including without limitation C/C++, Java, JavaScript, Pearl, Visual Basic, .NET, and the like. The main memory 820 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 825 may optionally include an internal memory 830 and/or a removable medium 835, for example a floppy disk drive, a magnetic tape drive, a compact disc (CD) drive, a digital versatile disc (DVD) drive, other optical drive, a flash memory drive, etc. The removable medium 835 is read from and/or written to in a well-known manner. Removable storage medium 835 may be, for example, a floppy disk, magnetic tape, CD, DVD, SD card, etc.

The removable storage medium 835 is a non-transitory computer-readable medium having stored thereon computer executable code (i.e., software) and/or data. The computer software or data stored on the removable storage medium 835 is read into the system 805 for execution by the processor 815.

In alternative example implementations, secondary memory 825 may include other similar means for allowing computer programs or other data or instructions to be loaded into the system 805. Such means may include, for example, an external storage medium 850 and an interface 845. Examples of external storage medium 850 may include an external hard disk drive or an external optical drive, or and external magneto-optical drive.

Other examples of secondary memory 825 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 835 and communication interface 845, which allow software and data to be transferred from an external medium 850 to the system 805.

System 805 may include a communication interface 845. The communication interface 845 allows software and data to be transferred between system 805 and external devices (e.g. printers), networks, or information sources. For example, computer software or executable code may be transferred to system 805 from a network server via communication interface 845. Examples of communication interface 845 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 805 with a network or another computing device.

Communication interface 845 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 845 are generally in the form of electrical communication signals 860. These signals 860 are preferably provided to communication interface 845 via a communication channel 855. In one example implementation, the communication channel 855 may be a wired or wireless network, or any variety of other communication links. Communication channel 855 carries signals 860 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 820 and/or the secondary memory 825. Computer programs can also be received via communication interface 845 and stored in the main memory 820 and/or the secondary memory 825. Such computer programs, when executed, enable the system 805 to perform the various functions of the present invention as previously described.

In this description, the term “computer readable medium” is used to refer to any non-transitory computer readable storage media used to provide computer executable code (e.g., software and computer programs) to the system 805. Examples of these media include main memory 820, secondary memory 825 (including internal memory 830, removable medium 835, and external storage medium 850), and any peripheral device communicatively coupled with communication interface 845 (including a network information server or other network device). These non-transitory computer readable mediums are means for providing executable code, programming instructions, and software to the system 805.

In an example implementation that is implemented using software, the software may be stored on a computer readable medium and loaded into the system 805 by way of removable medium 835, I/O interface 840, or communication interface 845. In such an example implementation, the software is loaded into the system 805 in the form of electrical communication signals 860. The software, when executed by the processor 815, preferably causes the processor 815 to perform the inventive features and functions previously described herein.

In an example implementation, I/O interface 840 provides an interface between one or more components of system 805 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 805 also includes optional wireless communication components that facilitate wireless communication over a voice and over a data network. The wireless communication components comprise an antenna system 865, a radio system 870, and a baseband system 875. In the system 805, radio frequency (RF) signals are transmitted and received over the air by the antenna system 865 under the management of the radio system 870.

In one example implementation, the antenna system 865 may comprise one or more antennae and one or more multiplexors (not shown) that perform a switching function to provide the antenna system 865 with transmit and receive signal paths. In the receive path, received RF signals can be coupled from a multiplexor to a low noise amplifier (not shown) that amplifies the received RF signal and sends the amplified signal to the radio system 870.

In alternative example implementations, the radio system 870 may comprise one or more radios that are configured to communicate over various frequencies. In one example implementation, the radio system 870 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 870 to the baseband system 875.

If the received signal contains audio information, then baseband system 875 decodes the signal and converts it to an analog signal. Then the signal is amplified and sent to a speaker. The baseband system 875 also receives analog audio signals from a microphone. These analog audio signals are converted to digital signals and encoded by the baseband system 875. The baseband system 875 also codes the digital signals for transmission and generates a baseband transmit audio signal that is routed to the modulator portion of the radio system 870. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 865 where the signal is switched to the antenna port for transmission.

The baseband system 875 is also communicatively coupled with the processor 815. The central processing unit 815 has access to data storage areas 820 and 825. The central processing unit 815 is preferably configured to execute instructions (i.e., computer programs or software) that can be stored in the memory 820 or the secondary memory 825. Computer programs can also be received from the baseband processor 865 and stored in the data storage area 820 or in secondary memory 825, or executed upon receipt. Such computer programs, when executed, enable the system 805 to perform the various functions of the present invention as previously described. For example, data storage areas 820 may include various software modules (not shown).

FIGS. 9-30 illustrate graphical user interfaces for client player development application in accordance with various example implementations. The Admin portal can include a Log in page. The admin can log into the system as follows: Admin user can login with this screen. Enter email ID and password and then click on the login button. To reset password “forget password” link can be used. When the admin logs into the system, they would land upon the herein page. The admin can filter users by clicking on the filter criteria such as ‘Instructors’, ‘Parents’, ‘Players’, ‘coaches’ and ‘scouts’.

Invite Users: Admin can invite users, if he/she knows their first name, last name, email address, affiliation, and the user type. The system would send the registration code to the user on his/her email address. Mail to invited users: The herein screen shows an example for the user—Anthony Clark. The system has sent the registration code to her email ID. Invitation request: All the notifications including the invitation request notification can appear in the list shown herein. Invited Notifications: In the next tab of “invited Notifications”, the user can view the invitations sent by the admin. Logout: Admin can logout from the system with the ‘Logout’ button.

Parent: Self-sign up of parent: Though the parent can self-sign up for the app he/she needs an approval from the admin. He/she can fill up the form and signup. System can ask to set up username and password. After setting up the user name and password, system can send an approval request to the admin.

Parent can get an “invite code” in his/her email, with this code the parent can register with the app. After a successful registration, the parent can be able to use the app. Screen shows the menu for the parent user. Parent can add a player, send association request to the instructor and the coach, also can share videos of their players to the instructor. Add player: From the side menu bar, tap on the ‘add player’ to add player. The user would complete the form and send the invite to the player. Upload video: To upload a video, the parent can search the player. Select one of the player whose video he/she wants to upload. Video List: Parent can see the list of videos for the players. (For now. In the next deliverable, the parent can see the videos of a particular player selected) To add a description to a video, the user would click on “Add description” in the video list.

Parent can see the list of videos in “feeds”. To upload a video, the parent has to choose the source of the video by clicking on “upload” and then “take video” or “choose from album” (from the pop up menu). By tapping on video, the parent can view the video. Association request from the instructor to the parent: Parent can view association request from the instructors. From the side menu bar tap on “association request” and herein screen can appear. The user can accept or reject a request here. A success message is displayed when parent accepts a request. If the parent rejects a request, a confirmation dialogue box appears to confirm the request before the executing the same.

Select player for video upload: If there is more than one player then the system would show a popup for “select player” as shown in screen herein. After selecting a player the instructor can upload a video. Video list: The parent can see the video list here. He/she would tap on the shortcut menu to write a description of the video. The parent would add a description of the video in screen as shown herein. The parent can view the list of videos in the screen. To upload a video, the parent may choose the source of the video by clicking on “upload” and then “take video” or “choose from album” (from the pop up menu). He/she can view the video by tapping on the video.

Player: Player can receive an invitation from their parent, by using the credentials sent by the parent, player can log into the system. The Video List: Player can upload a video by choosing the source of the video by first clicking on “upload” and then “take video” or “choose from album” (from the pop up menu). The player can write a description for the video uploaded. The player can view the list of videos uploaded by him/her.

Instructor: Sign up form: The instructor can sign up for app and send request to the admin; select the role; set username and password For instructors, the side menu bar can appear. Invite user: When instructor taps the “invite user” button, screen appears asking the user role. Instructor can select one of the roles. Instructor can send invite to ‘player’ to add player. An Association request: Instructor can send association request to players and coaches.

Coach Sign up form: Coach can sign up for the app. Admin would accept the request and system would send “register code”. By using that “register code” coach can login to app.; select the role; set user name and password; display menu list in side menu bar.

Association request on behalf of the player, the parent can accept this association request.

Video list: Coach can upload a video for scout, he/she can select a player for whom he/she wants to upload the video; and can add description to the video. Coach can upload a video using the source of video as “take a video” or “choose from album”. For example, by tapping on video coach can view the video.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A system comprising:
non-transitory memory to store player performance data and player evaluation data for a plurality of players; and
a processor operatively coupled to the memory, wherein the processor is configured to:
manage a plurality of player profiles, wherein a player profile of the plurality of player profiles is associated with multimedia content, and wherein the player profile is linked with a primary account and one or more secondary accounts;
receive input from the one or more secondary accounts linked with the player profile;
update the player profile in view of the input;
generate a player report based on the updated player profile; and
provide the player report to at least the primary account linked to the player profile.

2. The system of claim 1, wherein the processor is further configured to:
automatically route an assessment request for the received input to one or more of the secondary accounts; and
receive the assessment from the one or more secondary accounts to update the player profile.

3. The system of claim 2, wherein the assessment request for the received input is routed to the one or more of the secondary accounts is based on a type of received input, the account the input is received from, or a rule.

4. The system of claim 2, wherein the player profile further comprises performance data, a lesson plan, and a master evaluation rating for the player.

5. The system of claim 4, wherein the received input is multimedia content and the received assessment comprises an evaluation rating of the multimedia content.

6. The system of claim 5, wherein to update the player profile with the received input further comprises re-calculating the master evaluation rating for the player in view of the evaluation rating of the multimedia content.

7. The system of claim 4, wherein the received input is game performance data; and
wherein to update the player profile in view of the input further comprises recalculating the master evaluation rating for the player based on the assessment of the game performance data.

8. The system of claim 1, wherein the received input is associated with performance data for other profiles of the plurality of player profiles that are teammates of the player; and
wherein to update the player profile in view of the input further comprises weighting an evaluation rating of the player profile in view of the performance data of the other profiles.

9. The system of claim 1, wherein the received input includes multimedia content and the wherein the player report comprise at least a portion of the multimedia content.

10. The system of claim 9, wherein the processor is further configured to:
provide the player report with assessment information and evaluation information hidden.

11. The system of claim 1, wherein the processor is further configured to:
automatically route an assessment request for the received input to a secondary account of an instructor; and
update the player profile based on the assessment from the secondary account of the instructor.

12. The system of claim 1, wherein the one or more secondary accounts are classified as instructor accounts, scout accounts, assistant coach accounts, parental accounts, or supporter accounts.

13. The system of claim 1, wherein the primary account is associated with a coach or an instructor.

14. The system of claim 1, wherein the player profile further comprises performance data, a lesson plan, and a master evaluation rating for the player; and wherein the processor is further configured to:
manage a lesson plan for the one or more player profiles, wherein the development lesson plan for a player profile is adapted based on at least the evaluation rating and performance data associated with the player profile.

15. The system of claim 1, wherein the processor is configured to:
provide an instructor interface to assess videos of player performance, maintain a lesson plan for the player profile, and message the one or more secondary profiles linked to the player profile.

16. The system of claim 1, wherein the processor is configured to:
provide a coach interface to review a plurality of player profiles assigned to a group, wherein the coach interface comprising video playback and assessments for each of the plurality of player profiles of the group.

17. The system of claim 1, wherein the processor is configured to:
provide a parent interface to access the player profile and messages with the primary account and one or more secondary accounts linked to the player profile.

18. A method comprising:
managing a plurality of player profiles, wherein a player profile of the plurality of player profiles is associated with multimedia content, and wherein the player profile is linked with a primary account and one or more secondary accounts;
receiving input from the one or more secondary accounts linked with the player profile;
updating the player profile in view of the input;
generating a player report based on the updated player profile; and
provide the player report to at least the primary account linked to the player profile.
